(19) United States
(12) Patent Application Publication
(10) Pub. No.: US 2024/0235184 A1
(43) Pub. Date: Jul. 11, 2024

(54) METHOD AND SYSTEM FOR IDENTIFYING DOMINANT OVERVOLTAGE OF HIGH-PROPORTION NEW ENERGY POWER SYSTEM, ELECTRONIC DEVICE, STORAGE MEDIUM AND COMPUTER PROGRAM PRODUCT

(71) Applicant: China Electric Power Research Institute, Beijing (CN)

(72) Inventors: Shiyun XU, Beijing (CN); Huadong SUN, Beijing (CN); Yiming WANG, Beijing (CN); Bing ZHAO, Beijing (CN); Jingtian BI, Beijing (CN); Shuyan WANG, Beijing (CN)

(73) Assignee: China Electric Power Research Institute, Beijing (CN)

(21) Appl. No.: 18/559,561

(22) PCT Filed: Dec. 6, 2022
(86) PCT No.: PCT/CN2022/136790

§ 371 Date: Nov. 7, 2023

(30) Foreign Application Priority Data
Apr. 29, 2022 (CN) 202210475787.1

(51) Int. Cl. H02H 7/22

(52) U.S. Cl. CPC H02H 7/22

(57) ABSTRACT

A method for identifying a dominant overvoltage of a high-proportion new energy power system includes the following operations. A voltage amplitude of a new energy terminal and a voltage amplitude of an alternating-current (AC) bus at any moment after faults of the new energy terminal and the AC bus are cleared, are determined. An overvoltage limit ratio is determined according to a ratio of the voltage amplitude of the new energy terminal to the voltage amplitude of the AC bus. A critical overvoltage limit ratio is determined. A maximum new energy terminal voltage value and a maximum AC bus voltage value bearable for the new energy terminal and the AC bus are determined respectively. Identification of a dominant voltage safety constraint is performed and an identification result is determined.

### CROSS-REFERENCE TO RELATED APPLICATIONS

This application is filed based on and claims priority to Chinese Patent application No. 202210475787.1 filed on Apr. 29, 2022 and entitled “METHOD AND SYSTEM FOR IDENTIFYING DOMINANT OVERVOLTAGE OF HIGH-PROPORTION NEW ENERGY POWER SYSTEM”, the contents of which are hereby incorporated by reference in its entirety.

### TECHNICAL FIELD

The disclosure relates to, but is not limited to, the technical field of safety and stability analysis for a high-proportion new energy power system, and in particular to a method and system for identifying a dominant overvoltage of a high-proportion new energy power system, an electronic device, a storage medium, and a computer program product.

### BACKGROUND

With the increasing proportion of power electronic devices such as new energy power generation devices or the like in installed capacity of a power system, safety and stability characteristics of the power system are undergoing significant changes. Safety issues of new power systems, represented by overvoltage, have become increasingly prominent, which greatly restricts access scales of the new energy power generation devices in the power system.

In a high-proportion new energy power system, there are numerous causation and rich function mechanisms to induce overvoltage, and there are obvious differences in possibility of overvoltage occurred to different devices and buses in a power grid and risks caused by the overvoltage. Therefore, it is of great practical significance to analyze risks and their correlation relationships of overvoltage of different devices and buses, locate a dominant overvoltage constraint and further take corresponding suppression and protection measures, to guide design of controllers in the new energy power generation devices and safety and guide stability analysis and control of the high-proportion new energy power system.

However, existing researches mainly focus on calculation and evaluation of degree of overvoltage of the power system, with little focus on analysis and research of correlation relationships of overvoltage among different devices and buses in the power grid, and especially, research on a method for identifying a dominant overvoltage by considering an overvoltage limit has not been reported yet. In a word, a method for identifying a dominant overvoltage of a high-proportion new energy power system by considering dynamics of a phase locked loop (PLL), is still absent at present.

### SUMMARY

Embodiments of the disclosure provides a method and system for identifying a dominant overvoltage of a high-proportion new energy power system, an electronic device, a storage medium, and a computer program product.

According to an aspect of the embodiments of the disclosure, there is provided a method for identifying a dominant overvoltage of a high-proportion new energy power system, the method includes the following operations.

A voltage amplitude of a new energy terminal and a voltage amplitude of an alternating-current (AC) bus at any moment after faults of the new energy terminal and the AC bus are cleared, are determined respectively.

An overvoltage limit ratio is determined according to a ratio of the voltage amplitude of the new energy terminal to the voltage amplitude of the AC bus.

A critical overvoltage limit ratio is determined.

A maximum new energy terminal voltage value and a maximum AC bus voltage value bearable for the new energy terminal and the AC bus are determined respectively.

Identification of a dominant voltage safety constraint is performed according to the overvoltage limit ratio, the critical overvoltage limit ratio, the maximum new energy terminal voltage value and the maximum AC bus voltage value, and an identification result is determined.

According to another aspect of the embodiments of the disclosure, there is provided a system for identifying a dominant overvoltage of a high-proportion new energy power system, the system includes a voltage amplitude calculation unit, an overvoltage limit ratio determination unit, a critical overvoltage limit ratio determination unit, a maximum voltage value calculation unit and an identification unit.

The voltage amplitude calculation unit is configured to determine a voltage amplitude of a new energy terminal and a voltage amplitude of an AC bus at any moment after faults of the new energy terminal and the AC bus are cleared respectively.

The overvoltage limit ratio determination unit is configured to determine an overvoltage limit ratio according to a ratio of the voltage amplitude of the new energy terminal to the voltage amplitude of the AC bus.

The critical overvoltage limit ratio determination unit is configured to determine a critical overvoltage limit ratio.

The maximum voltage value calculation unit is configured to determine a maximum new energy terminal voltage value and a maximum AC bus voltage value bearable for the new energy terminal and the AC bus respectively.

The identification unit is configured to perform identification of a dominant voltage safety constraint according to the overvoltage limit ratio, the critical overvoltage limit ratio, the maximum new energy terminal voltage value and the maximum AC bus voltage value, and determine an identification result.

According to another aspect of the embodiments of the disclosure, an embodiment of the disclosure provides a computer-readable storage medium, having stored thereon a computer program, the program implements operations of the method for identifying a dominant overvoltage of a high-proportion new energy power system when the program is executed by a processor.

According to another aspect of the embodiments of the disclosure, an embodiment of the disclosure provides an electronic device, the electronic device includes the above computer-readable storage medium and one or more processors configured to execute the program in the computer-readable storage medium.

According to another aspect of the embodiments of the disclosure, an embodiment of the disclosure provides a computer program product, the computer program product includes a computer instruction, the computer instruction enables a computer device to perform operations of the above method for identifying a dominant overvoltage of a high-proportion new energy power system when the computer instruction is executed on the computer device.

The embodiments of the disclosure provide a method and system for identifying a dominant overvoltage of a high-proportion new energy power system, including the following operations. A voltage amplitude of a new energy terminal and a voltage amplitude of an AC bus at any moment after faults of the new energy terminal and the AC bus are cleared, are determined respectively. An overvoltage limit ratio is determined according to a ratio of the voltage amplitude of the new energy terminal to the voltage amplitude of the AC bus. A critical overvoltage limit ratio is determined. A maximum new energy terminal voltage value and a maximum AC bus voltage value bearable for the new energy terminal and the AC bus are determined respectively. Identification of a dominant voltage safety constraint is performed according to the overvoltage limit ratio, the critical overvoltage limit ratio, the maximum new energy terminal voltage value and the maximum AC bus voltage value, and an identification result is determined. The embodiments of the disclosure take a voltage source converter (VSC) grid-connected system as a research object, establish a voltage analytical calculation model which considers dynamic characteristics of a PLL, and reveal a correlation relationship between voltage dynamics of the VSC grid-connected system and dynamics of the PLL; and take an overvoltage limit ratio as an index, and implement identification of a dominant voltage constraint by considering an overvoltage limit. The embodiments of the disclosure may provide strong support for safety and stability analysis and control of the high-proportion new energy power system.

### BRIEF DESCRIPTION OF THE DRAWINGS

Exemplary embodiments of the disclosure may be understood more completely with reference to the following drawings.

FIG. 1 is a flowchart of a method 100 for identifying a dominant overvoltage of a high-proportion new energy power system according to an embodiment of the disclosure.

FIG. 2 is a schematic diagram of a model of a VSC grid-connected system which considers dynamics of a PLL according to an embodiment of the disclosure.

FIG. 3 is a topology diagram of a control link of a PLL according to an embodiment of the disclosure.

FIG. 4 is a schematic diagram of a voltage variation of a VSC grid-connected system in a large disturbance transient process according to an embodiment of the disclosure.

FIG. 5 is a schematic diagram of an electrical vector relationship according to an embodiment of the disclosure.

FIG. 6 is a schematic structural diagram of a system 600 for identifying a dominant overvoltage of a high-proportion new energy power system according to an embodiment of the disclosure.

### DETAILED DESCRIPTION

Exemplary embodiments of the disclosure are described now with reference to the drawings. However, the disclosure may be implemented in many different forms and is not limited to the embodiments described here. These embodiments are provided to disclose the disclosure thoroughly and completely, and to fully convey the scope of the disclosure to those skilled in the art. Terms of the exemplary embodiments represented in the drawings are not intended to limit the disclosure. In the drawings, the same unit/component is marked with the same reference symbol.

Unless otherwise specified, terms used here (including technological terms) have commonly understood meanings to those skilled in the art. Furthermore, it may be understood that terms defined in commonly used dictionaries should be understood to have meanings consistent with the context of their relevant field, and should not be understood as idealistic or too formal meanings.

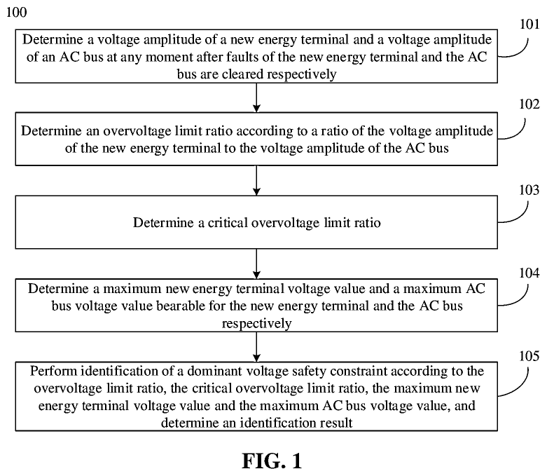

FIG. 1 is a flowchart of a method 100 for identifying a dominant overvoltage of a high-proportion new energy power system according to an embodiment of the disclosure. As shown in FIG. 1, the method for identifying a dominant overvoltage of a high-proportion new energy power system provided by the embodiment of the disclosure takes a voltage source converter (VSC) grid-connected system as a research object, establishes a voltage analytical calculation model which considers dynamic characteristics of a phase locked loop (PLL), and reveals a correlation relationship between voltage dynamics of the VSC grid-connected system and dynamics of the PLL; and takes an overvoltage limit ratio as an index, and implements identification of a dominant voltage constraint by considering an overvoltage limit. The embodiments of the disclosure may provide strong support for safety and stability analysis and control of the high-proportion new energy power system. The method 100 for identifying a dominant overvoltage of a high-proportion new energy power system provided by the embodiment of the disclosure starts from operation 101. At 101, a voltage amplitude of a new energy terminal and a voltage amplitude of an alternating-current (AC) bus at any moment after faults of the new energy terminal and the AC bus are cleared, are determined respectively.

Preferably, the operation of determining the voltage amplitude of the new energy terminal and the voltage amplitude of the AC bus at any moment after faults of the new energy terminal and the AC bus are cleared respectively, includes the following formulas:

$${U}_{r} ( t ) = \sqrt{{( {u}_{r}^{d} ( t ) )}^{2} + {( {u}_{r}^{q} ( t ) )}^{2}} = \sqrt{{U}_{g}^{2} - 2 {U}_{g} {ω}_{pll} ( t ) {L}_{Σ} cos ( {δ}_{pll} ( t ) ) + {( {ω}_{pll} ( t ) {L}_{Σ} )}^{2}} \qquad ( 1 )$$

$${U}_{s} ( t ) = \sqrt{{( {u}_{s}^{d} ( t ) )}^{2} + {( {u}_{s}^{q} ( t ) )}^{2}} = \sqrt{{U}_{g}^{2} - 2 {U}_{g} {ω}_{pll} ( t ) {L}_{g} cos ( {δ}_{pll} ( t ) ) + {( {ω}_{pll} ( t ) {L}_{g} )}^{2}} \qquad ( 2 )$$

here Uᵣ(t) is a voltage amplitude of the new energy terminal at a moment t; uᵣ^{q}(t) is a q-axis component of a voltage of the new energy terminal at the moment t; uᵣ^{d}(t) is a d-axis component of the voltage of the new energy terminal at the moment t; U_{g} is an electromotive force of an equivalent power supply of an AC power grid; ω_{pH}(t) is an angular frequency of a PLL at the moment t; δ_{pH}(t) is a phase locked angle of the PLL at the moment t; L_{T} is an equivalent reactance from the new energy terminal to an infinite power supply; Uₛ(t) is a voltage amplitude of the AC bus at the moment t; uₛ^{q}(t) is a q-axis component of a voltage of the AC bus at the moment t; uₛ^{d}(t) is a d-axis component of the voltage of the AC bus at the moment t; and L_{q} is an equivalent reactance from the AC bus to the infinite power supply.

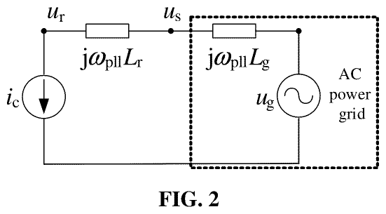

VSC is a commonly used grid-connected interface of a new energy power generation device. The embodiment of the disclosure establishes a VSC grid-connected system model which considers dynamics of the PLL, as shown in FIG. 2. A voltage equation thereof is:

$$\{ \begin{matrix}{u}_{r}^{d} = {u}_{g}^{d} + {i}_{c}^{q} ( {ω}_{pll} {L}_{Σ} ) \\ {u}_{r}^{q} = - {u}_{g}^{q} - {i}_{c}^{d} ( {ω}_{pll} {L}_{Σ} )\end{matrix} \qquad ( 3 )$$

here i_{c} is an input current; uᵣ, uₛ and u_{g} are a voltage of the new energy terminal, a voltage of the AC bus and an electromotive force of an equivalent power supply of an AC power grid, respectively; and L_{c}, Lᵣ and L_{g} are an equivalent inductance of a filter, a grid-connected inductance and an equivalent inductance of a receiving end grid, respectively.

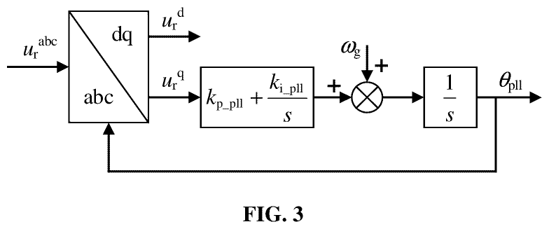

VSC adopts a grid voltage orientation based on the PLL. A topology diagram of a control link of the PLL is shown in FIG. 3, and a control system equation thereof is:

$$\{ \begin{matrix}{\dot{θ}}_{pll} = {ω}_{pll} \\ {\dot{ω}}_{pll} = {k}_{p \_ pll} {\dot{u}}_{r}^{q} + {k}_{i \_ pll} {u}_{r}^{q}\end{matrix} \qquad ( 4 )$$

here θ_{pH} is a phase-locked angle of the PLL, k_{p_pH} and k_{i_pH} are PI parameters of the PLL, uᵣ^{q} is a q-axis component of a voltage of the new energy terminal. In the embodiment of the disclosure, a “dot” added above a letter represents calculation of a derivative of a variable represented by the letter with respect to time, for example, represents calculation of a derivative of x with respect to time.

In the embodiment of the disclosure, a control strategy for overvoltage occurred to the VSC grid-connected system is analyzed.

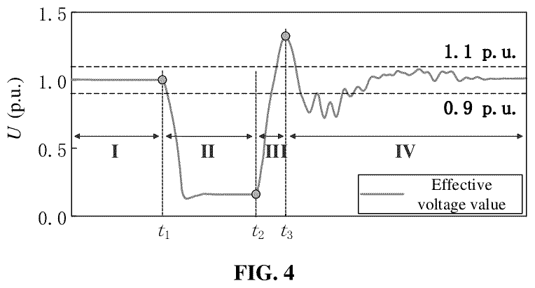

Uncoordinated control of a new energy generation device with a characteristic of reactive power control in a large disturbance transient process is a main cause of overvoltage occurred to the VSC grid-connected system. The embodiment of the disclosure is based on state switching of a VSC control outer loop at a grid side of the new energy power generation device, and divides the large disturbance transient process into four stages, as shown in FIG. 4.
Stage I: a stable operation state (t<t₁). At this stage, the VSC grid-connected system operates in a rated state, the electromotive force of the equivalent power supply of the AC power grid U_{g}=1.0 p.u., and the control outer loop is in a put-in state. Under the stable operation state, an active power Pᵣ and reactive power Qᵣ injected by VSC into a power system are 1.0 p.u. and 0 respectively. Therefore, there are the following assumptions: iᵣ^{d}=−1.0, and iᵣ^{q}=0.
Stage II: a low voltage crossing state (t₁<t<t₂). A large disturbance fault occurs to the VSC grid-connected system at a moment t₁, which causes voltage at a grid-connected point dropping rapidly, and the VSC grid-connected system enters the low voltage crossing state due to a too low voltage caused by dropping, until the large disturbance fault is cleared at a moment t₂, here a dropping degree of the voltage of the new energy terminal is related to factors such as a fault type, a fault degree, etc. As an example, at this stage, the electromotive force of the equivalent power supply of the AC power grid U_{g}=0.1 p.u., and the control outer loop is in a cut-out state. The active power Pᵣ and reactive power Qᵣ injected by VSC into the power system are 0 p.u. and 1.0 p.u., respectively. Therefore, there are the following assumptions: iᵣ^{d}=0, and iᵣ^{q}=−1.0. It should be noted that the VSC grid-connected system will experience a brief stage where the voltage of the terminal is greater than 0.9 p.u. in an initial stage of the fault. Because the voltage drops rapidly, duration of this stage is relatively short, and overvoltage discussed in the embodiment of the disclosure often does not occur in this stage, thus an impact of this process may be ignored.
Stage III: an initial stage after the fault is cleared (t₂<t<t₃). The VSC grid-connected system enters a fault recovery stage at a moment t₂, and due to impacts of voltage measurement, feedback and other links, the control outer loop of the new energy power generation device may be delayed by about 20 ms to put-in again, that is, at a moment t₃. As an example, at this stage, the electromotive force of the equivalent power supply of the AC power grid U_{g}=1.0 p.u., and the control outer loop is in a cut-out state. The active power Pᵣ and reactive power Qᵣ injected by VSC into the power system are 0 p.u. and 1.0 p.u., respectively. Therefore, there are the following assumptions: iᵣ^{d}=0, and iᵣ^{q}=−1.0. Generally speaking, overvoltage of the VSC grid-connected system is often caused by uncoordinated reactive power control of the new energy power generation device, which often occurs in stage III.
Stage IV: restoring to the stable operation state (t>t₃). The VSC grid-connected system makes the control outer loop to put-in again at the moment t₃, and the active power Pᵣ and reactive power Qᵣ injected by VSC into the power system are 1.0 p.u. and 0 respectively. Therefore, there are the following assumptions: iᵣ^{d}=−1.0, and iᵣ^{q}=0. After undergoing a power oscillation, the VSC grid-connected system returns to the rated operation state.

Furthermore, some new energy power generation devices may recognize a high voltage crossing state since they are equipped with corresponding control strategies for high voltage crossing. However, considering delay effects of voltage measurement, feedback and other links, the strategies for the high voltage crossing will actually function by delaying to stage IV, without making any impact on stage III.

Therefore, in the embodiment of the disclosure, an analytical expression between overvoltage dynamics and PLL dynamics of the new energy terminal and the AC bus in stage III is established.

### 1. Analytical Expression Between Overvoltage Dynamics and PLL Dynamics of the New Energy Terminal in Stage III

After the large disturbance fault occurs to the system, the VSC grid-connected system generates overvoltage due to short-time reactive power surplus in stage III. Based on the current assumptions of stage III, the equation (3) may be simplified as:

$$\{ \begin{matrix}{u}_{r}^{d} = {u}_{g}^{d} - {ω}_{pll} {L}_{Σ} \\ {u}_{r}^{q} = - {u}_{g}^{q}\end{matrix} \qquad ( 5 )$$

Therefore, a voltage amplitude Uᵣ of the new energy terminal may be expressed by:

$${U}_{r} ( t ) = \sqrt{{( {u}_{r}^{d} ( t ) )}^{2} + {( {u}_{r}^{q} ( t ) )}^{2}} = \sqrt{{U}_{g}^{2} - 2 {U}_{g} {ω}_{pll} ( t ) {L}_{Σ} cos ( {δ}_{pll} ( t ) ) + {( {ω}_{pll} ( t ) {L}_{Σ} )}^{2}} \qquad ( 6 )$$

### 2. Analytical Expression Between Overvoltage Dynamics and PLL Dynamics of an AC Device in Stage III

Taking an AC bus as an example, a voltage amplitude Uₛ of the AC bus after a large disturbance is cleared, is expressed by:

$${U}_{s} ( t ) = \sqrt{{( {u}_{s}^{d} ( t ) )}^{2} + {( {u}_{s}^{q} ( t ) )}^{2}} = \sqrt{{U}_{g}^{2} - 2 {U}_{g} {ω}_{pll} ( t ) {L}_{g} cos ( {δ}_{pll} ( t ) ) + {( {ω}_{pll} ( t ) {L}_{g} )}^{2}} \qquad ( 7 )$$

here Uᵣ(t) is a voltage amplitude of the new energy terminal at a moment t; uᵣ^{q}(t) is a q-axis component of a voltage of the new energy terminal at the moment t; uᵣ^{d}(t) is a d-axis component of the voltage of the new energy terminal at the moment t; U_{g} is an electromotive force of an equivalent power supply of an AC power grid; ω_{pH}(t) is an angular frequency of a PLL at the moment t; δ_{pH}(t) is a phase locked angle of the PLL at the moment t; L_{Σ} is an equivalent reactance from the new energy terminal to an infinite power supply; Uₛ(t) is a voltage amplitude of the AC bus at the moment t; uₛ^{q}(t) is a q-axis component of a voltage of the AC bus at the moment t; uₛ^{d}(t) is a d-axis component of the voltage of the AC bus at the moment t; and L_{g} is an equivalent reactance from the AC bus to the infinite power supply.

### 3. Analysis of a Correlation Relationship Among Overvoltage Dynamics of Different Devices and Buses in the VSC Grid-Connected System

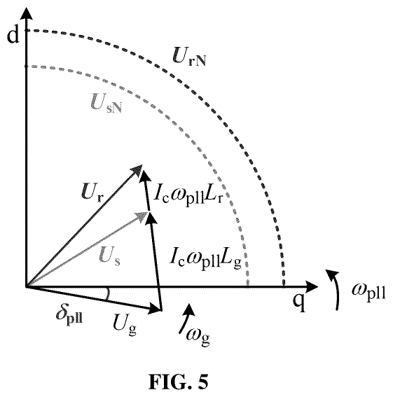

FIG. 5 shows a relationship between main electrical quantities in the VSC grid-connected system, and dynamic processes of the voltage Uᵣ of the new energy terminal and the voltage Uₛ of the AC bus are similar in a transient process. In FIG. 5, an outermost arc is the voltage amplitude Uᵣ of the new energy terminal, and an inner arc is the voltage amplitude Uₛ of the AC bus.

At 102, an overvoltage limit ratio is determined according to a ratio of the voltage amplitude of the new energy terminal to the voltage amplitude of the AC bus.

In the embodiment of the disclosure, the overvoltage limit ratio is determined according to the voltage amplitude of the new energy terminal to the voltage amplitude of the AC bus, to determine a device and AC bus to which voltage-exceeding-limit firstly occurs, of the VSC grid-connected system, that is, to determine the dominant voltage safety constraint. The embodiment of the disclosure defines the ratio of the voltage amplitude Uᵣ of the new energy terminal to the voltage amplitude Uₛ of the AC bus as the overvoltage limit ratio N.

At 103, a critical overvoltage limit ratio is determined.

Preferably, the operation of determining the critical overvoltage limit ratio includes the following formula:

$${N}_{m} = \sqrt{1 + \frac{{L}_{r}}{{L}_{g}} - [ \frac{{L}_{r} {U}_{g}^{2}}{{L}_{g}} - {ω}_{g}^{2} ( {L}_{r}^{2} + {L}_{r} {L}_{g} ) ] \frac{1}{{U}_{sN}^{2}}} \qquad ( 8 )$$

here Nₘ is the critical overvoltage limit ratio; Lᵣ is an equivalent reactance between the new energy terminal and the AC bus; U_{g} is an electromotive force of an equivalent power supply of an AC power grid; ω_{g} an angular frequency of the AC power grid; L_{g} is an equivalent reactance from the AC bus to an infinite power supply; and U_{sN} is a preset overvoltage limit value of the AC bus.

In the embodiment of the disclosure, in case that the voltage amplitude Uᵣ of the new energy terminal (or the voltage amplitude Uₛ of the AC bus) does not exceed a maximum bearable voltage value U_{r_max} (or U_{s_max}), the device and bus to which overvoltage-exceeding-limit occurs, of the power system are related to the overvoltage limit ratio N. It is assumed that when N=Nₘ, the voltage Uᵣ of the new energy terminal and the voltage Uₛ of the AC bus reach their respective voltage safety constraints simultaneously, and the critical overvoltage limit ratio Nₘ is expressed by:

$${N}_{m} = \sqrt{1 + \frac{{L}_{r}}{{L}_{g}} - [ \frac{{L}_{r} {U}_{g}^{2}}{{L}_{g}} - {ω}_{g}^{2} ( {L}_{r}^{2} + {L}_{r} {L}_{g} ) ] \frac{1}{{U}_{sN}^{2}}} \qquad ( 9 )$$

here Nₘ is the critical overvoltage limit ratio; Lᵣ is an equivalent reactance between the new energy terminal and the AC bus; U_{g} is an electromotive force of an equivalent power supply of an AC power grid; ω_{g} is an angular frequency of the AC power grid; L_{g} is an equivalent reactance from the AC bus to an infinite power supply; and U_{sN} is a preset overvoltage limit value of the AC bus.

At 104, a maximum new energy terminal voltage value and a maximum AC bus voltage value bearable for the new energy terminal and the AC bus are determined respectively.

Preferably, the operation of determining the maximum new energy terminal voltage value and the maximum AC bus voltage value bearable for the new energy terminal and the AC bus respectively includes the following formulas:

$${U}_{r \_ m a x} = \sqrt{{U}_{g}^{2} + 2 {U}_{g} {ω}_{g} {L}_{Σ} + {( {ω}_{g} {L}_{Σ} )}^{2}} \qquad ( 10 )$$

$${U}_{s \_ m a x} = \sqrt{{U}_{g}^{2} + 2 {U}_{g} {ω}_{g} {L}_{g} + {( {ω}_{g} {L}_{g} )}^{2}} \qquad ( 11 )$$

here U_{r_max} is the maximum new energy terminal voltage value; U_{s_max} is the maximum AC bus voltage value; U_{g} is an electromotive force of an equivalent power supply of an AC power grid; ω_{g} is an angular frequency of the AC power grid; L_{Σ} is an equivalent reactance from the new energy terminal to an infinite power supply; and L_{g} is an equivalent reactance from the AC bus to the infinite power supply.

At 105, identification of a dominant voltage safety constraint is performed according to the overvoltage limit ratio, the critical overvoltage limit ratio, the maximum new energy terminal voltage value and the maximum AC bus voltage value, and an identification result is determined.

Preferably, the operation of performing identification of the dominant voltage safety constraint according to the overvoltage limit ratio, the critical overvoltage limit ratio, the maximum new energy terminal voltage value and the maximum AC bus voltage value, and determining the identification result includes the following operations.

It is determined that voltage-exceeding-limit firstly occurs to the new energy terminal, in response to that the voltage amplitude of the new energy terminal is less than or equal to the maximum new energy terminal voltage value, and the overvoltage limit ratio is less than or equal to 1.

It is determined that the voltage-exceeding-limit firstly occurs to the new energy terminal, in response to that the voltage amplitude of the new energy terminal is less than or equal to the maximum new energy terminal voltage value, and the overvoltage limit ratio is greater than 1 and less than the critical overvoltage limit ratio.

It is determined that the voltage-exceeding-limit simultaneously occurs to the new energy terminal and the AC bus, in response to that the voltage amplitude of the new energy terminal is less than or equal to the maximum new energy terminal voltage value, and the overvoltage limit ratio is equal to the critical overvoltage limit ratio.

It is determined that the voltage-exceeding-limit firstly occurs to the AC bus, in response to that the voltage amplitude of the AC bus is less than or equal to the maximum AC bus voltage value, and the overvoltage limit ratio is greater than the critical overvoltage limit ratio.

In the embodiment of the disclosure, the dominant voltage safety constraint of the high-proportion new energy power system is identified based on the overvoltage limit ratio N. Exemplarily, the following type 1, type 2, type 3 and type 4 are included.
Type 1: when Uᵣ≤U_{r_max} and N≤1, in this type, the voltage amplitude Uᵣ of the new energy terminal is less than or equal to the voltage amplitude Uₛ of the AC bus. It may be known from the vector relationship between electrical quantities in FIG. 5 that the voltage-exceeding-limit firstly occurs to the new energy terminal, and is constrained by an overvoltage protection setting value U_{rN} of the new energy terminal.
Type 2: when Uᵣ≤SU_{r_max} and 1<N<Nₘ, it may be known from the above descriptions that a protection action triggered by overvoltage under this configuration strategy firstly occurs to the new energy terminal and is constrained by the voltage amplitude Uᵣ of the new energy terminal.
Type 3: when Uᵣ≤U_{r_max} and N=Nₘ, under this protection configuration strategy, transient voltage rise of the new energy terminal and the AC bus caused by disturbance will simultaneously reach their respective overvoltage limits.
Type 4: when Uₛ≤U_{s_max} and N>Nₘ, a protection action triggered by overvoltage under this configuration strategy firstly occurs to the AC bus and is constrained by the voltage amplitude Uₛ of the AC bus.

Furthermore, in case that Uᵣ (or Uₛ) exceeds the maximum bearable voltage value U_{r_max} (or U_{s_max}), the overvoltage limit is invalid. In summary, a method for identifying a dominant constraint based on the overvoltage limit ratio is shown in Table 1.

The embodiment of the disclosure focuses on an overvoltage problem caused after clearing the large disturbance fault of the high-proportion new energy power system. The embodiment of the disclosure takes a VSC grid-connected system as a research object, establishes a voltage analytical calculation model which considers dynamic characteristics of a PLL, and reveals a correlation relationship between voltage dynamics of the VSC grid-connected system and dynamics of the PLL; and proposes an overvoltage limit ratio as an index, and implements identification of a dominant overvoltage constraint by considering an overvoltage limit. Relevant research results may provide strong support for safety and stability analysis and control of the high-proportion new energy power system.

One possible implementation process applicable to the embodiment of the disclosure is described below, and may include the following operations 1 to 4.
Operation 1, a correlation relationship between voltage dynamics of the VSC grid-connected system and dynamics of the PLL is analyzed, and an analytical expression which may characterize the correlation relationship is established.
Operation 2, a control strategy of the VSC grid-connected system during a large disturbance transient is analyzed, and a stage where overvoltage occurs is identified.
Operation 3, a coupling relationship among overvoltage of different devices and buses of the high-proportion new energy power system is analyzed, and an analytical expression between voltage dynamics and dynamics of the PLL in the overvoltage stage is established.
Operation 4, an overvoltage limit ratio is calculated, and a dominant overvoltage constraint of the high-proportion new energy power system is determined based on the overvoltage limit ratio.

In an actual engineering practice, in order to prevent irreversible damages such as insulation breakdown, electrical stress tension, or the like from occurring to the new energy power generation device due to overvoltage, the overvoltage protection setting value of the new energy terminal is usually set to U_{rN}=1.3 p.u.; an insulation limit U_{sN} for overvoltage of the AC bus is usually set as the following formula:

$$U {\text{?}}_{N} = \frac{{k}_{s} \times {U}_{I}}{{U}_{B}} \qquad ( 12 )$$

$$\text{?} \text{indicates text missing or illegible when filed}$$

In the formula, U₁ is a highest operation voltage at a voltage level of the AC bus; U_{B} is a reference voltage; and kₛ is an overvoltage capability coefficient. Taking 110 kV AC bus as an example,

$$U {\text{?}}_{N} = \frac{1.3 \times 121}{115} = 1.367 p . u \qquad ( 13 )$$

$$\text{?} \text{indicates text missing or illegible when filed}$$

It may be obtained that an overvoltage limit ratio N=0.955 under this overvoltage protection configuration strategy. It may be known from Table 1 that the new energy terminal firstly reaches its overvoltage protection setting value, which triggers a rapid terminal tripping action, and a dominant voltage safety constraint is a voltage of the new energy terminal.

TABLE 1

| | Range of | Position of | |
|---|---|---|---|
| Overvoltage | overvoltage | dominant voltage | Dominant factors |
| limit ratio | limit | safety constraint | of boundary |
| N ≤ 1 | U_{rN} ≤ Uᵣ_{_{—}}ₘₐₓ | new energy | protection setting |
| | | terminal | value of the terminal |
| | U_{rN} > Uᵣ_{_{—}}ₘₐₓ | overvoltage limit is invalid | |
| 1 < N < Nm | U_{rN} ≤ Uᵣ_{_{—}}ₘₐₓ | new energy | protection setting |
| | | terminal | value of the terminal |
| | U_{rN} > Uᵣ_{_{—}}ₘₐₓ | overvoltage limit is invalid | |
| N = Nm | U_{rN} ≤ Uᵣ_{_{—}}ₘₐₓ | new energy | dominate |
| | | terminal, bus | simultaneously |
| | U_{rN} > Uᵣ_{_{—}}ₘₐₓ | overvoltage limit is invalid | |
| N > Nm | U_{rN} ≤ Uᵣ_{_{—}}ₘₐₓ | bus | insulation limit |
| | | | of the bus |

| | |
|---|---|
| U_{rN} > Uᵣ_{_{—}}ₘₐₓ | overvoltage limit is invalid |

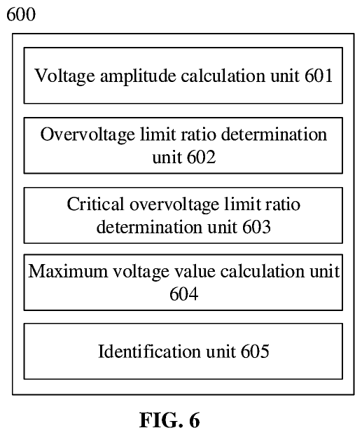

FIG. 6 is a schematic structural diagram of a system 600 for identifying a dominant overvoltage of a high-proportion new energy power system according to an embodiment of the disclosure. As shown in FIG. 6, the system 600 for identifying a dominant overvoltage of a high-proportion new energy power system provided by the embodiment of the disclosure includes a voltage amplitude calculation unit 601, an overvoltage limit ratio determination unit 602, a critical overvoltage limit ratio determination unit 603, a maximum voltage value calculation unit 604 and an identification unit 605.

Preferably, the voltage amplitude calculation unit 601 is configured to determine a voltage amplitude of a new energy terminal and a voltage amplitude of an AC bus at any moment after faults of the new energy terminal and the AC bus are cleared respectively.

Preferably, the voltage amplitude calculation unit 601 is specifically configured to determine the voltage amplitude of the new energy terminal and the voltage amplitude of the AC bus at any moment after faults of the new energy terminal and the AC bus are cleared respectively according to the following formulas (14) and (15):

$$\begin{matrix}U \text{?} ( t ) = \sqrt{{( {u}_{r}^{d} ( t ) )}^{2} + {( {u}_{r}^{q} ( t ) )}^{2}} \\ = \sqrt{{U}_{g}^{2} - 2 U \text{?} {ω}_{pll} ( t ) {L}_{\sum } cos ( {δ}_{pll} ( t ) ) + {( {ω}_{pll} ( t ) {L}_{Σ} )}^{2}}\end{matrix} \qquad ( 14 )$$

$$\begin{matrix}U \text{?} ( t ) = \sqrt{{( u \text{?} ( t ) )}^{2} + {( u \text{?} ( t ) )}^{2}} \\ = \sqrt{U \text{?} - 2 U \text{?} {ω}_{pll} ( t ) L \text{?} cos ( {δ}_{pll} ( t ) ) + {( {ω}_{pll} ( t ) {L}_{g} )}^{2}}\end{matrix} \qquad ( 15 )$$

$$\text{?} \text{indicates text missing or illegible when filed}$$

here Uₜ(t) is a voltage amplitude of the new energy terminal at a moment t; uᵣ^{q}(t) is a q-axis component of a voltage of the new energy terminal at the moment t; uᵣ^{d}(t) is a d-axis component of the voltage of the new energy terminal at the moment t; U_{g} is an electromotive force of an equivalent power supply of an AC power grid; ω_{pH}(t) is an angular frequency of a PLL at the moment t; δ_{pH}(t) is a phase locked angle of the PLL at the moment t; L_{Σ} is an equivalent reactance from the new energy terminal to an infinite power supply; Uₛ(t) is a voltage amplitude of the AC bus at the moment t; uₛ^{q}(t) is a q-axis component of a voltage of the AC bus at the moment t; uₛ^{d}(t) is a d-axis component of the voltage of the AC bus at the moment t; and L_{g} is an equivalent reactance from the AC bus to the infinite power supply.

Preferably, the overvoltage limit ratio determination unit 602 is configured to determine an overvoltage limit ratio according to a ratio of the voltage amplitude of the new energy terminal to the voltage amplitude of the AC bus.

Preferably, the critical overvoltage limit ratio determination unit 603 is configured to determine a critical overvoltage limit ratio.

Preferably, the critical overvoltage limit ratio determination unit 603 is specifically configured to determine the critical overvoltage limit ratio according to the following formula (16):

$${N}_{m} = \sqrt{1 + \frac{L \text{?}}{{L}_{g}} - [ \frac{L \text{?} {U}_{g}^{2}}{L \text{?}} - {ω}_{g}^{2} ( {L}_{r}^{2} + {L}_{r} L \text{?} ) ] \frac{1}{U \text{?}}} \qquad ( 16 )$$

$$\text{?} \text{indicates text missing or illegible when filed}$$

here Nₘ is the critical overvoltage limit ratio; Lᵣ is an equivalent reactance between the new energy terminal and the AC bus; U_{g} is an electromotive force of an equivalent power supply of an AC power grid; ω_{g} is an angular frequency of the AC power grid; L_{g} is an equivalent reactance from the AC bus to an infinite power supply; and U_{sN} is a preset overvoltage limit value of the AC bus.

Preferably, the maximum voltage value calculation unit 604 is configured to determine a maximum new energy terminal voltage value and a maximum AC bus voltage value bearable for the new energy terminal and the AC bus respectively.

Preferably, the maximum voltage value calculation unit 604 is specifically configured to determine the maximum new energy terminal voltage value and the maximum AC bus voltage value bearable for the new energy terminal and the AC bus respectively according to the following formulas (17) and (18):

$${U}_{r \_ max} = \sqrt{{U}_{g}^{2} + 2 {U}_{g} {ω}_{g} {L}_{Σ} + {( {ω}_{g} {L}_{Σ} )}^{2}} \qquad ( 17 )$$

$${U}_{s \_ max} = \sqrt{{U}_{g}^{2} + 2 {U}_{g} {ω}_{g} {L}_{g} + {( {ω}_{g} {L}_{g} )}^{2}} \qquad ( 18 )$$

here U_{r_max} is the maximum new energy terminal voltage value; U_{s_max} is the maximum AC bus voltage value; U_{g} is an electromotive force of an equivalent power supply of an AC power grid; ω_{g} is an angular frequency of the AC power grid; L_{Σ} is an equivalent reactance from the new energy terminal to an infinite power supply; and L_{g} is an equivalent reactance from the AC bus to the infinite power supply.

Preferably, the identification unit 605 is configured to perform identification of a dominant voltage safety constraint according to the overvoltage limit ratio, the critical overvoltage limit ratio, the maximum new energy terminal voltage value and the maximum AC bus voltage value, and determine an identification result.

Preferably, the identification unit 605 configured to perform identification of the dominant voltage safety constraint according to the overvoltage limit ratio, the critical overvoltage limit ratio, the maximum new energy terminal voltage value and the maximum AC bus voltage value, and determine the identification result, includes that the identification unit is configured to:
determine that voltage-exceeding-limit firstly occurs to the new energy terminal, in response to that the voltage amplitude of the new energy terminal is less than or equal to the maximum new energy terminal voltage value, and the overvoltage limit ratio is less than or equal to 1;
determine that the voltage-exceeding-limit firstly occurs to the new energy terminal, in response to that the voltage amplitude of the new energy terminal is less than or equal to the maximum new energy terminal voltage value, and the overvoltage limit ratio is greater than 1 and less than the critical overvoltage limit ratio;
determine that the voltage-exceeding-limit simultaneously occurs to the new energy terminal and the AC bus, in response to that the voltage amplitude of the new energy terminal is less than or equal to the maximum new energy terminal voltage value, and the overvoltage limit ratio is equal to the critical overvoltage limit ratio; and
determine that the voltage-exceeding-limit firstly occurs to the AC bus, in response to that the voltage amplitude of the AC bus is less than or equal to the maximum AC bus voltage value, and the overvoltage limit ratio is greater than the critical overvoltage limit ratio.

The system 600 for identifying a dominant overvoltage of a high-proportion new energy power system according to the embodiment of the disclosure corresponds to the method 100 for identifying a dominant overvoltage of a high-proportion new energy power system according to another embodiment of the disclosure, and will not be elaborated here.

According to another aspect of the embodiments of the disclosure, an embodiment of the disclosure provides a computer-readable storage medium, having stored thereon a computer program, the program implements any one of operations of the method for identifying a dominant overvoltage of a high-proportion new energy power system when the program is executed by a processor.

According to another aspect of the embodiments of the disclosure, an embodiment of the disclosure provides an electronic device, the electronic device includes the above computer-readable storage medium and one or more processors configured to execute the program in the computer-readable storage medium.

According to another aspect of the embodiments of the disclosure, an embodiment of the disclosure provides a computer program product, the computer program product includes a computer instruction, the computer instruction enables a computer device to perform operations of the above method for identifying a dominant overvoltage of a high-proportion new energy power system when the computer instruction is executed on the computer device.

The disclosure has been described with reference to a few embodiments. However, it is well known by those skilled in the art that other embodiments of the disclosure except the above disclosed embodiments fall within the scope of the disclosure equivalently, as limited by the appended patent claims.

In general, all terms used in the claims are interpreted according to their ordinary meanings in the technical field, unless otherwise explicitly defined there. All references to “a/the/these [device, component, etc.]” are openly interpreted as at least one instance of the device, component, etc., unless otherwise explicitly stated. It is unnecessary for the operations of any method disclosed here to be executed in the exact orders as disclosed, unless explicitly stated.

It may be understood by those skilled in the art that the embodiments of the disclosure may be provided as methods, systems or computer program products. Therefore, the disclosure may take forms of embodiments with entire hardware, embodiments with entire software, or embodiments combining software with hardware aspects. Furthermore, the disclosure may take a form of a computer program product implemented on one or more computer-available storage media (including, but not limited to a disk storage, a Compact Disk Read Only Memory (CD-ROM), an optical storage, etc.) containing computer-available program codes.

The disclosure is described with reference to flowcharts and/or block diagrams of methods, devices (systems) and computer program products according to the embodiments of the disclosure. It should be understood that computer program instructions may implement each flow and/or block in the flowcharts and/or the block diagrams, as well as combinations of flows and/or blocks in the flowcharts and/or the block diagrams. These computer program instructions may be provided to a processor of a general purpose computer, a specialized computer, an embedded processor or another programmable data processing device to generate a machine, such that instructions executed by the processor of the computer or another programmable data processing device generate a device configured to implement functions specified in one or more flows of the flowcharts and/or one or more blocks of the block diagrams.

These computer program instructions may also be stored in a computer-readable memory which may guide a computer or another programmable data processing device to operate in a specific manner, such that the instructions stored in the computer-readable memory generate a manufactured product including an instruction device, and the instruction device implements functions specified in one or more flows of the flowcharts and/or one or more blocks of the block diagrams.

These computer program instructions may also be loaded onto a computer or another programmable data processing device, such that a series of operations are executed on the computer or another programmable device to generate computer-implemented processing, and thus the instructions executed on the computer or another programmable device provide operations for implementing functions specified in one or more flows of the flowcharts and/or one or more blocks of the block diagrams.

Finally, it should be noted that the above embodiments are only intended to explain technical solutions of the disclosure and are not intended to limit the technical solutions. Although the disclosure has been described in detail with reference to the above embodiments, it should be understood by those of ordinary skill in the art that modifications or equivalent replacements may be still made to specific embodiments of the disclosure, and any modification or equivalent replacement which do not depart from the spirit and scope of the disclosure should fall within the scope of protection of the claims of the disclosure.

1. A method for identifying a dominant overvoltage of a high-proportion new energy power system, comprising:
determining a voltage amplitude of a new energy terminal and a voltage amplitude of an alternating-current (AC) bus at any moment after faults of the new energy terminal and the AC bus are cleared respectively;
determining an overvoltage limit ratio according to a ratio of the voltage amplitude of the new energy terminal to the voltage amplitude of the AC bus;
determining a critical overvoltage limit ratio;
determining a maximum new energy terminal voltage value and a maximum AC bus voltage value bearable for the new energy terminal and the AC bus respectively; and
performing identification of a dominant voltage safety constraint according to the overvoltage limit ratio, the critical overvoltage limit ratio, the maximum new energy terminal voltage value and the maximum AC bus voltage value, and determining an identification result.

2. The method of claim 1, wherein determining the voltage amplitude of the new energy terminal and the voltage amplitude of the AC bus at any moment after faults of the new energy terminal and the AC bus are cleared respectively, comprises:
$$\begin{matrix}U \text{?} ( t ) = \sqrt{{( {u}_{r}^{d} ( t ) )}^{2} + {( {u}_{r}^{q} ( t ) )}^{2}} \\ = \sqrt{U \text{?} - 2 U \text{?} {ω}_{pll} ( t ) {L}_{Σ} cos ( {δ}_{pll} ( t ) ) + {( {ω}_{pll} ( t ) {L}_{Σ} )}^{2}}\end{matrix} ,$$
$$\begin{matrix}U \text{?} ( t ) = \sqrt{{( u \text{?} ( t ) )}^{2} + {( u \text{?} ( t ) )}^{2}} \\ = \sqrt{U \text{?} - 2 U \text{?} {ω}_{pll} ( t ) L \text{?} cos ( {δ}_{pll} ( t ) ) + {( {ω}_{pll} ( t ) {L}_{g} )}^{2}}\end{matrix} ,$$
$$\text{?} \text{indicates text missing or illegible when filed}$$
wherein Uᵣ(t) is a voltage amplitude of the new energy terminal at a moment t; uₜ^{q}(t) is a q-axis component of a voltage of the new energy terminal at the moment t; uₜ^{d}(t) is a d-axis component of the voltage of the new energy terminal at the moment t; U_{g} is an electromotive force of an equivalent power supply of an AC power grid; ω_{pH}(t) is an angular frequency of a phase locked loop (PLL) at the moment t; δ_{pH}(t) is a phase locked angle of the PLL at the moment t; L_{Σ} is an equivalent reactance from the new energy terminal to an infinite power supply; Uₛ(t) is a voltage amplitude of the AC bus at the moment t; uₛ^{q}(t) is a q-axis component of a voltage of the AC bus at the moment t; uₛ^{d}(t) is a d-axis component of the voltage of the AC bus at the moment t; and L_{g} is an equivalent reactance from the AC bus to the infinite power supply.

3. The method of claim 1, wherein determining the critical overvoltage limit ratio comprises:
$${N}_{m} = \sqrt{1 + \frac{L \text{?}}{{L}_{g}} - [ \frac{L \text{?} {U}_{g}^{2}}{L \text{?}} - {ω}_{g}^{2} ( {L}_{r}^{2} + {L}_{r} L \text{?} ) ] \frac{1}{{U}_{sN}^{2}}} ,$$
$$\text{?} \text{indicates text missing or illegible when filed}$$
wherein Nₘ is the critical overvoltage limit ratio; Lᵣ is an equivalent reactance between the new energy terminal and the AC bus; U_{g} is an electromotive force of an equivalent power supply of an AC power grid; ω_{g} is an angular frequency of the AC power grid; L_{g} is an equivalent reactance from the AC bus to an infinite power supply; and U_{sN} is a preset overvoltage limit value of the AC bus.

4. The method of claim 1, wherein determining the maximum new energy terminal voltage value and the maximum AC bus voltage value bearable for the new energy terminal and the AC bus respectively comprises:
$${U}_{r\_max} = \sqrt{{U}_{g}^{2} + 2 {U}_{g} {ω}_{g} {L}_{Σ} + {( {ω}_{g} {L}_{Σ} )}^{2}} ,$$
$${U}_{s \_ max} = \sqrt{{U}_{g}^{2} + 2 {U}_{g} {ω}_{g} {L}_{g} + {( {ω}_{g} {L}_{g} )}^{2}} ,$$
wherein U_{r_max} is the maximum new energy terminal voltage value; U_{s_max} is the maximum AC bus voltage value; U_{g} is an electromotive force of an equivalent power supply of an AC power grid; ω_{g} is an angular frequency of the AC power grid; L_{Σ} is an equivalent reactance from the new energy terminal to an infinite power supply; and L_{g} is an equivalent reactance from the AC bus to the infinite power supply.

5. The method of claim 1, wherein performing identification of the dominant voltage safety constraint according to the overvoltage limit ratio, the critical overvoltage limit ratio, the maximum new energy terminal voltage value and the maximum AC bus voltage value, and determining the identification result comprise:
determining that voltage-exceeding-limit firstly occurs to the new energy terminal, in response to that the voltage amplitude of the new energy terminal is less than or equal to the maximum new energy terminal voltage value, and the overvoltage limit ratio is less than or equal to 1;
determining that the voltage-exceeding-limit firstly occurs to the new energy terminal, in response to that the voltage amplitude of the new energy terminal is less than or equal to the maximum new energy terminal voltage value, and the overvoltage limit ratio is greater than 1 and less than the critical overvoltage limit ratio;
determining that the voltage-exceeding-limit simultaneously occurs to the new energy terminal and the AC bus, in response to that the voltage amplitude of the new energy terminal is less than or equal to the maximum new energy terminal voltage value, and the overvoltage limit ratio is equal to the critical overvoltage limit ratio; and
determining that the voltage-exceeding-limit firstly occurs to the AC bus, in response to that the voltage amplitude of the AC bus is less than or equal to the maximum AC bus voltage value, and the overvoltage limit ratio is greater than the critical overvoltage limit ratio.

6. An electronic device for identifying a dominant overvoltage of a high-proportion new energy power system, comprising:
a processor; and
a memory storing a computer program executable by the processor;
wherein the processor is configured to:
determine a voltage amplitude of a new energy terminal and a voltage amplitude of an alternating-current (AC) bus at any moment after faults of the new energy terminal and the AC bus are cleared respectively;
determine an overvoltage limit ratio according to a ratio of the voltage amplitude of the new energy terminal to the voltage amplitude of the AC bus;
determine a critical overvoltage limit ratio;
determine a maximum new energy terminal voltage value and a maximum AC bus voltage value bearable for the new energy terminal and the AC bus respectively; and
perform identification of a dominant voltage safety constraint according to the overvoltage limit ratio, the critical overvoltage limit ratio, the maximum new energy terminal voltage value and the maximum AC bus voltage value, and determine an identification result.

7. The electronic device of claim 6, wherein the processor is configured to determine the voltage amplitude of the new energy terminal and the voltage amplitude of the AC bus at any moment after faults of the new energy terminal and the AC bus are cleared respectively by formulas:
$$\begin{matrix}U \text{?} ( t ) = \sqrt{{( {u}_{r}^{d} ( t ) )}^{2} + {( {u}_{r}^{q} ( t ) )}^{2}} \\ = \sqrt{U \text{?} - 2 U \text{?} {ω}_{pll} ( t ) {L}_{Σ} cos ( {δ}_{pll} ( t ) ) + {( {ω}_{pll} ( t ) {L}_{Σ} )}^{2}}\end{matrix} ,$$
$$\begin{matrix}U \text{?} ( t ) = \sqrt{{( u \text{?} ( t ) )}^{2} + {( u \text{?} ( t ) )}^{2}} \\ = \sqrt{U \text{?} - 2 U \text{?} {ω}_{pll} ( t ) L \text{?} cos ( {δ}_{pll} ( t ) ) + {( {ω}_{pll} ( t ) L \text{?} )}^{2}}\end{matrix} ,$$
$$\text{?} \text{indicates text missing or illegible when filed}$$
wherein Uᵣ(t) is a voltage amplitude of the new energy terminal at a moment t; uᵣ^{q}(t) is a q-axis component of a voltage of the new energy terminal at the moment t; uᵣ^{d}(t) is a d-axis component of the voltage of the new energy terminal at the moment t; U_{g} is an electromotive force of an equivalent power supply of an AC power grid; ω_{pH}(t) is an angular frequency of a phase locked loop (PLL) at the moment t; δ_{pH}(t) is a phase locked angle of the PLL at the moment t; L_{Σ} is an equivalent reactance from the new energy terminal to an infinite power supply; Uₛ(t) is a voltage amplitude of the AC bus at the moment t; uₛ^{q}(t) is a q-axis component of a voltage of the AC bus at the moment t; uₛ^{d}(t) is a d-axis component of the voltage of the AC bus at the moment t; and is an equivalent reactance from the AC bus to the infinite power supply.

8. The electronic device of claim 6, wherein the processor is configured to determine the critical overvoltage limit ratio by a formula:
$${N}_{m} = \sqrt{1 + \frac{L \text{?}}{{L}_{g}} - [ \frac{L \text{?} {U}_{g}^{2}}{L \text{?}} - {ω}_{g}^{2} ( {L}_{r}^{2} + {L}_{r} L \text{?} ) ] \frac{1}{{U}_{sN}^{2}}} ,$$
$$\text{?} \text{indicates text missing or illegible when filed}$$
wherein Nₘ is the critical overvoltage limit ratio; Lᵣ is an equivalent reactance between the new energy terminal and the AC bus; U_{g} is an electromotive force of an equivalent power supply of an AC power grid; ω_{g} is an angular frequency of the AC power grid; L_{g} is an equivalent reactance from the AC bus to an infinite power supply; and U_{sN} is a preset overvoltage limit value of the AC bus.

9. The electronic device of claim 6, wherein the processor is configured to determine the maximum new energy terminal voltage value and the maximum AC bus voltage value bearable for the new energy terminal and the AC bus respectively by formulas:
$${U}_{r \_ max} = \sqrt{{U}_{g}^{2} + 2 {U}_{g} {ω}_{g} {L}_{Σ} + {( {ω}_{g} {L}_{Σ} )}^{2}} ,$$
$${U}_{s\_max} = \sqrt{{U}_{g}^{2} + 2 {U}_{g} {ω}_{g} {L}_{g} + {( {ω}_{g} {L}_{g} )}^{2}} ,$$
wherein U_{r_max} is the maximum new energy terminal voltage value; U_{s_max} is the maximum AC bus voltage value; U_{g} is an electromotive force of an equivalent power supply of an AC power grid; ω_{g} is an angular frequency of the AC power grid; L_{Σ} is an equivalent reactance from the new energy terminal to an infinite power supply; and L_{g} is an equivalent reactance from the AC bus to the infinite power supply.

10. The electronic device of claim 6, wherein the processor is configured to:
determine that voltage-exceeding-limit firstly occurs to the new energy terminal, in response to that the voltage amplitude of the new energy terminal is less than or equal to the maximum new energy terminal voltage value, and the overvoltage limit ratio is less than or equal to 1;
determine that the voltage-exceeding-limit firstly occurs to the new energy terminal, in response to that the voltage amplitude of the new energy terminal is less than or equal to the maximum new energy terminal voltage value, and the overvoltage limit ratio is greater than 1 and less than the critical overvoltage limit ratio;
determine that the voltage-exceeding-limit simultaneously occurs to the new energy terminal and the AC bus, in response to that the voltage amplitude of the new energy terminal is less than or equal to the maximum new energy terminal voltage value, and the overvoltage limit ratio is equal to the critical overvoltage limit ratio; and
determine that the voltage-exceeding-limit firstly occurs to the AC bus, in response to that the voltage amplitude of the AC bus is less than or equal to the maximum AC bus voltage value, and the overvoltage limit ratio is greater than the critical overvoltage limit ratio.

11. A non-transitory computer-readable storage medium, having stored thereon a computer program, the program implementing steps of a method for identifying a dominant overvoltage of a high-proportion new energy power system when the program is executed by a processor, wherein the method comprises:
determining a voltage amplitude of a new energy terminal and a voltage amplitude of an alternating-current (AC) bus at any moment after faults of the new energy terminal and the AC bus are cleared respectively;
determining an overvoltage limit ratio according to a ratio of the voltage amplitude of the new energy terminal to the voltage amplitude of the AC bus;
determining a critical overvoltage limit ratio;
determining a maximum new energy terminal voltage value and a maximum AC bus voltage value bearable for the new energy terminal and the AC bus respectively; and
performing identification of a dominant voltage safety constraint according to the overvoltage limit ratio, the critical overvoltage limit ratio, the maximum new energy terminal voltage value and the maximum AC bus voltage value, and determining an identification result.

12. (canceled)

13. (canceled)

14. The non-transitory computer-readable storage medium of claim 11, wherein determining the voltage amplitude of the new energy terminal and the voltage amplitude of the AC bus at any moment after faults of the new energy terminal and the AC bus are cleared respectively, comprises:
$$\begin{matrix}U \text{?} ( t ) = \sqrt{{( {u}_{r}^{d} ( t ) )}^{2} + {( {u}_{r}^{q} ( t ) )}^{2}} \\ = \sqrt{U \text{?} - 2 U \text{?} {ω}_{pll} ( t ) {L}_{Σ} cos ( {δ}_{pll} ( t ) ) + {( {ω}_{pll} ( t ) {L}_{Σ} )}^{2}}\end{matrix} ,$$
$$\begin{matrix}U \text{?} ( t ) = \sqrt{{( u \text{?} ( t ) )}^{2} + {( u \text{?} ( t ) )}^{2}} \\ = \sqrt{U \text{?} - 2 U \text{?} {ω}_{pll} ( t ) L \text{?} cos ( {δ}_{pll} ( t ) ) + {( {ω}_{pll} ( t ) L \text{?} )}^{2}}\end{matrix} ,$$
$$\text{?} \text{indicates text missing or illegible when filed}$$
wherein Uᵣ(t) is a voltage amplitude of the new energy terminal at a moment t; uᵣ^{q}(t) is a q-axis component of a voltage of the new energy terminal at the moment t; uᵣ^{d}(t) is a d-axis component of the voltage of the new energy terminal at the moment t; U_{g} is an electromotive force of an equivalent power supply of an AC power grid; ω_{pH}(t) is an angular frequency of a phase locked loop (PLL) at the moment t; δ_{pH}(t) is a phase locked angle of the PLL at the moment t; L_{Σ} is an equivalent reactance from the new energy terminal to an infinite power supply; Uₛ(t) is a voltage amplitude of the AC bus at the moment t; uₛ^{q}(t) is a q-axis component of a voltage of the AC bus at the moment t; uₛ^{d}(t) is a d-axis component of the voltage of the AC bus at the moment t; and L_{g} is an equivalent reactance from the AC bus to the infinite power supply.

15. The non-transitory computer-readable storage medium of claim 11, wherein determining the critical overvoltage limit ratio comprises:
$${N}_{m} = \sqrt{1 + \frac{L \text{?}}{{L}_{g}} - [ \frac{L \text{?} {U}_{g}^{2}}{L \text{?}} - {ω}_{g}^{2} ( {L}_{r}^{2} + {L}_{r} L \text{?} ) ] \frac{1}{{U}_{sN}^{2}}} ,$$
$$\text{?} \text{indicates text missing or illegible when filed}$$
wherein Nₘ is the critical overvoltage limit ratio; Lᵣ is an equivalent reactance between the new energy terminal and the AC bus; U_{g} is an electromotive force of an equivalent power supply of an AC power grid; ω_{g} is an angular frequency of the AC power grid; L_{g} is an equivalent reactance from the AC bus to an infinite power supply; and U_{sN} is a preset overvoltage limit value of the AC bus.

16. The non-transitory computer-readable storage medium of claim 11, wherein determining the maximum new energy terminal voltage value and the maximum AC bus voltage value bearable for the new energy terminal and the AC bus respectively comprises:
$${U}_{r \_ max} = \sqrt{{U}_{g}^{2} + 2 {U}_{g} {ω}_{g} {L}_{Σ} + {( {ω}_{g} {L}_{Σ} )}^{2}} ,$$
$${U}_{s \_ max} = \sqrt{{U}_{g}^{2} + 2 {U}_{g} {ω}_{g} {L}_{g} + {( {ω}_{g} {L}_{g} )}^{2}} ,$$
wherein U_{r_max} is the maximum new energy terminal voltage value; U_{s_max} is the maximum AC bus voltage value; U_{g} is an electromotive force of an equivalent power supply of an AC power grid; ω_{g} is an angular frequency of the AC power grid; L_{Σ} is an equivalent reactance from the new energy terminal to an infinite power supply; and L_{g} is an equivalent reactance from the AC bus to the infinite power supply.

17. The non-transitory computer-readable storage medium of claim 11, wherein performing identification of the dominant voltage safety constraint according to the overvoltage limit ratio, the critical overvoltage limit ratio, the maximum new energy terminal voltage value and the maximum AC bus voltage value, and determining the identification result comprise:
determining that voltage-exceeding-limit firstly occurs to the new energy terminal, in response to that the voltage amplitude of the new energy terminal is less than or equal to the maximum new energy terminal voltage value, and the overvoltage limit ratio is less than or equal to 1;
determining that the voltage-exceeding-limit firstly occurs to the new energy terminal, in response to that the voltage amplitude of the new energy terminal is less than or equal to the maximum new energy terminal voltage value, and the overvoltage limit ratio is greater than 1 and less than the critical overvoltage limit ratio;
determining that the voltage-exceeding-limit simultaneously occurs to the new energy terminal and the AC bus, in response to that the voltage amplitude of the new energy terminal is less than or equal to the maximum new energy terminal voltage value, and the overvoltage limit ratio is equal to the critical overvoltage limit ratio; and
determining that the voltage-exceeding-limit firstly occurs to the AC bus, in response to that the voltage amplitude of the AC bus is less than or equal to the maximum AC bus voltage value, and the overvoltage limit ratio is greater than the critical overvoltage limit ratio.
